(19) United States
(12) Patent Application Publication
(10) Pub. No.: US 2026/0249743 A1
(43) Pub. Date: Aug. 27, 2026

(54) POWER BOOST SYSTEM FOR ELECTRIC VEHICLE

(71) Applicants: FCA US LLC, Auburn Hills, MI (US); Stellantis Auto SAS, Poissy (FR)

(72) Inventor: Bryon E Wasacz, Auburn Hills, MI (US)

(21) Appl. No.: 19/065,526

(22) Filed: Feb. 27, 2025

(51) Int. Cl. B60L 58/20; B60L 7/16; B60L 50/40; B60L 50/60

(52) U.S. Cl. CPC B60L 58/20; B60L 7/16; B60L 50/40; B60L 50/60; B60L 2210/14; B60L 2210/40; B60L 2250/28; B60L 2260/28

(57) ABSTRACT

An electrified vehicle includes an electric traction motor configured to generate drive torque, a high voltage (HV) battery system including a main HV battery for powering the electric traction motor under normal operating conditions, and an auxiliary energy storage system (ESS) configured to selectively provide power to the electric traction motor during a power boost mode. A control system includes a controller programmed to detect a driver selected command to operate the vehicle in the power boost mode, electrically connect the auxiliary ESS to the electric traction motor, and initiate the power boost mode, when one or more conditions are satisfied, by supplying power from the auxiliary ESS to the electric traction motor to enable the electric traction motor to operate with a higher power than what is available during the normal operating conditions with the main HV battery.

### FIELD

The present application relates generally to high voltage electrified powertrain vehicles and, more particularly, to systems and methods to boost power output of an electrified powertrain vehicle.

### BACKGROUND

An electrified vehicle (hybrid electric, plug-in hybrid electric, range-extended electric, battery electric, etc.) typically includes a high voltage (HV) battery system, a low voltage (LV) battery system, and at least one electric motor. The HV battery system is utilized to power the electric motor(s) and to recharge the LV battery system via a direct current to direct current (DC-DC) convertor. Some electrified vehicles are capable of providing a power increase for a short period of time. However, such systems achieve this power increase by implementing a torque reserve under normal drive modes, which holds back a certain amount of battery power below the full capability of the propulsion system. Accordingly, the full capability of the propulsion system is only available when the power increase is requested, and only for a short time. Thus, while conventional systems do work well for their intended purpose, there remains a need for improvement in the relevant art.

### SUMMARY

In accordance with one example aspect of the invention, an electrified vehicle is provided. In one example implementation, the electrified vehicle includes an electric traction motor configured to generate drive torque, a high voltage (HV) battery system including a main HV battery for powering the electric traction motor under normal operating conditions, and an auxiliary energy storage system (ESS) configured to selectively provide power to the electric traction motor during a power boost mode. A control system includes a controller programmed to detect a driver selected command to operate the vehicle in the power boost mode, electrically connect the auxiliary ESS to the electric traction motor, and initiate the power boost mode, when one or more conditions are satisfied, by supplying power from the auxiliary ESS to the electric traction motor to enable the electric traction motor to operate with a higher power than what is available during the normal operating conditions with the main HV battery.

In addition to the foregoing, the described vehicle may include one or more of the following features: wherein the main HV battery has a first voltage, and the auxiliary ESS has a second voltage that is higher than the first voltage; wherein the first voltage is approximately 800V and the second voltage is approximately 900V; a regenerative braking system configured to generate electrical power with the electric traction motor operating as a generator, and a boost converter electrically coupled between the electric traction motor and the auxiliary ESS, the boost converter configured to boost voltage from the regenerative braking system to a higher voltage for recharging the auxiliary ESS; and wherein the auxiliary ESS is a supercapacitor.

In addition to the foregoing, the described vehicle may include one or more of the following features: a power router switch configured to selectively electrically connect the auxiliary ESS to the electric traction motor; wherein the one or more conditions comprises a throttle of the vehicle exceeding a predetermined threshold; wherein the controller is further programmed to deactivate the power boost mode and disconnect the auxiliary ESS from the electric traction motor after a predetermined period of time has elapsed; wherein the controller is further programmed to deactivate the power boost mode if the one or more conditions are not satisfied with a predetermined amount of time; wherein the electric traction motor includes a first electric traction motor configured to drive a first set of vehicle wheels, and a second electric traction motor configured to drive a second set of vehicle wheels; and wherein during the power boost mode, the main HV battery powers the first electric traction motor, and the auxiliary ESS powers the second electric traction motor.

In accordance with another example aspect of the invention, a method of operating an electrified vehicle is provided. In one example, the electrified vehicle includes an electric traction motor, a main high voltage (HV) battery for powering the electric traction motor under normal operating conditions, and an auxiliary energy storage system (ESS) configured to selectively provide power to the electric traction motor during a power boost mode. In one example, the method includes: detecting, by a controller, a driver selected command to operate the vehicle in the power boost mode; electrically connecting, by the controller, the auxiliary ESS to the electric traction motor; and initiating, by the controller, the power boost mode when one or more conditions are satisfied, by supplying power from the auxiliary ESS to the electric traction motor to enable the electric traction motor to operate with a higher power than what is available during the normal operating conditions with the main HV battery.

In addition to the foregoing, the described method may include one or more of the following features: wherein the main HV battery has a first voltage, and the auxiliary ESS has a second voltage that is higher than the first voltage; wherein the electrified vehicle further includes a regenerative braking system configured to generate electrical power with the electric traction motor operating as a generator, a boost converter electrically coupled between the electric traction motor and the auxiliary ESS, the boost converter configured to boost voltage from the regenerative braking system to a higher voltage for recharging the auxiliary ESS, and a power router switch configured to selectively electrically connect the auxiliary ESS to the electric traction motor; and wherein the auxiliary ESS is an ultracapacitor.

In addition to the foregoing, the described method may include one or more of the following features: wherein the one or more conditions comprises a throttle of the vehicle exceeding a predetermined threshold; deactivating, by the controller, the power boost mode and disconnecting the auxiliary ESS from the electric traction motor after a predetermined period of time has elapsed; deactivating, by the controller, the power boost mode if the one or more conditions are not satisfied with a predetermined amount of time; wherein the electric traction motor includes a first electric traction motor configured to drive a first set of vehicle wheels, and a second electric traction motor configured to drive a second set of vehicle wheels; and powering the first electric traction motor with the main HV battery during the power boost mode, and powering the second electric traction motor with the auxiliary ESS during the power boost mode.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of an electrified vehicle having a high voltage battery control system, in accordance with the principles of the present disclosure;

FIG. 2 is a schematic diagram of an example architecture for the high voltage battery control system, in accordance with the principles of the present disclosure; and

FIG. 3 illustrates a flow diagram of an example method of operating the electrified vehicle of FIG. 1 in accordance with the principles of the present disclosure.

### DESCRIPTION

As previously described, some electrified powertrains are configured with an on-demand power increase for a short period of time. However, this requires a predetermined amount of power (torque reserve) to be held back from the full capability of the propulsion system in order to provide the power increase when requested. Thus, the full capability of the propulsion system is only available when the power increase is requested, and then only for a short period of time.

Accordingly, described herein are systems and methods for an electrified vehicle configured to provide an on-demand power boost above its full capability without requiring a power/torque reserve. In one example, the system utilizes a boost converter to boost the input voltage to an energy storage system (ESS) such as, for example, an ultracapacitor, a supercapacitor, or a superbattery. The source of the input power may be from a power inverter module during brake regeneration or from another ESS such as a high voltage (HV) battery. The propulsion system may include multiple ESS's each designed with different nominal voltages. The higher voltage ESS is thus configured to provide an additional power boost. In this way, the propulsion system is configured to produce additional power (e.g., ~30-50 kW) beyond what is normally available, rather than constantly holding back or reserving the additional power in order to provide the power boost on demand.

Propulsion system components are typically designed to operate, for example, at 400V or 800V nominally. These components may operate at various maximum current levels for given periods of time (e.g., 30 seconds). One way to get additional power from a power inverter module is to increase the current. However, if the system is already operating at a component's maximum current versus time duration, increasing the current beyond the maximum may cause damage to the component(s). Knowing that power=voltage * current, the system can increase the HV bus voltage instead of increasing the current.

Accordingly, the described propulsion system architecture utilizes an auxiliary ESS with higher nominal voltage than the main HV battery. For example, the main HV battery voltage may be 800V, and the auxiliary ESS voltage may be 900V. Under normal driving, the propulsion system is configured to operate off the HV battery (e.g., at 800V). When the driver selects a power boost mode, the propulsion system is configured to switch to the higher voltage auxiliary ESS, thereby enabling high power output (higher torque) while maintaining the same current. As such, the main, nominal HV bus voltage and the HV battery operate at the same voltage (e.g., 800V) and may be recharged under normal recharging operations/conditions. However, in order to charge or recharge the auxiliary ESS, the system utilizes a boost converter to boost the bus voltage (e.g., from 800V to 900V). For example, a boost converter is disposed on the electrical path from an electric drive module (EDM) back to the auxiliary ESS to boost the output voltage of the EDM during brake energy regeneration in order to boost the voltage and recharge the auxiliary ESS.

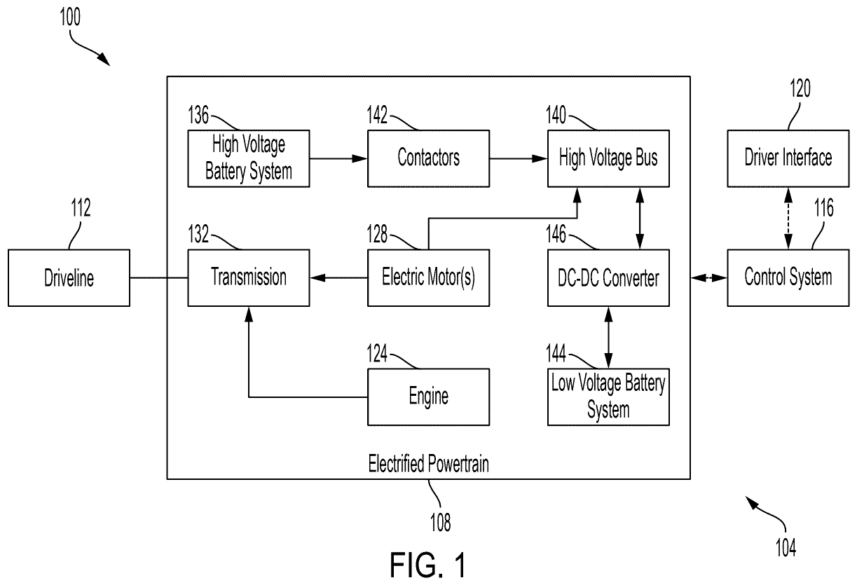

Referring now to FIG. 1, a functional block diagram of an electrified vehicle 100 having an example high voltage (HV) battery control system 104 according to the principles of the present application is illustrated. The vehicle 100 comprises an electrified powertrain 108 configured to generate and transfer drive torque to a driveline 112 for vehicle propulsion. A control system 116 is configured to control the electrified powertrain 108, such as to generate a desired amount of drive torque to satisfy a driver torque request received via a driver interface 120 (e.g., an accelerator pedal) and based on torque-related parameters. The electrified powertrain 108 comprises an optional internal combustion engine 124 configured to combust a mixture of air and fuel (e.g., gasoline) to generate drive torque at a crankshaft (not shown). The electrified powertrain 108 also comprises one or more electric motors 128 configured to, when operating as torque generators, generate drive torque using electrical energy from a high voltage (HV) battery system 136 connected to a HV bus 140 by a set of contactors 142.

It will be appreciated that the electrified vehicle 100 could have any suitable powertrain configuration. The drive torque from the electric motor(s) 128 and the optional engine 124 is transferred to the driveline 112 via a transmission 132. The electrified powertrain 108 further comprises a low voltage (e.g., 12V) battery system 144 that is connected directly or via a DC-DC converter 146 to the high voltage bus 140.

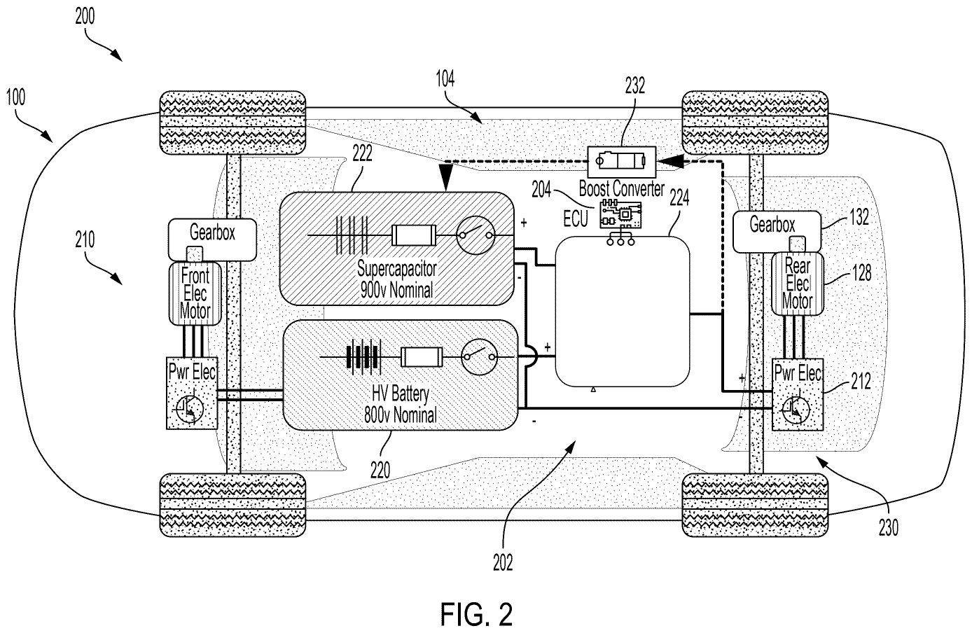

Referring now to FIG. 2, an example schematic diagram 200 of the electrified vehicle 100 and HV battery control system 104 according to the principles of the present application is illustrated. It will be appreciated that this is merely one exemplary configuration of the HV battery control system 104 and other implementations could be utilized. In general, the vehicle 100 includes a HV electrical system 202, a supervisory controller 204, and one or more sub-controllers (not shown) that collectively form the control system 116.

In the example embodiment, the HV electrical system 202 includes the HV battery system 136, which is configured to provide power to one or more electric drive modules (EDMs) 210. As shown, each EDM 210 includes an electric motor 128, a transmission 132 (e.g., a gearbox), and power electronics 212, such as a power inverter module (PIM). The HV battery system 136 includes a main HV battery 220 and an auxiliary ESS 222 (e.g., a supercapacitor, hybrid ultracapacitor, etc.), which are electrically connected to the EDMs 210 via a power router switch 224. In operation, the power router switch 224 is configured to function as a smart power switch, allowing either the main HV battery 220 or the auxiliary ESS 222 to be electrically interfaced to the power electronics 212.

In the example implementation, the auxiliary ESS 222 has a higher nominal voltage (e.g., 900V) than the main HV battery 220 nominal voltage (e.g., 800V). In this way, the auxiliary ESS 222 is configured to selectively provide a higher voltage to one or more of the EDMs 210 for increased power, as described herein in more detail.

The vehicle 100 also includes a regenerative braking system 230, which is configured to utilize the electric motor(s) 128 as a generator to generate electricity during vehicle braking to regenerate the main HV battery 220 and/or the auxiliary ESS 222. In order to recharge the auxiliary ESS 222, which has a higher nominal voltage, the HV electrical system 202 includes a boost converter 232 for boosting the voltage from the regenerative braking system 230 to a higher voltage for recharging the higher voltage auxiliary ESS 222. Although not shown, the HV electrical system 202 also includes a charging system for external recharging of the HV battery system 136.

In the example embodiment, the auxiliary ESS 222 is configured to selectively provide a power boost to one or more of the electric motors 128. For example, the driver may initiate a power boost mode via the driver interface 120 (e.g., by pressing a button on the dash, steering wheel, touchscreen, etc.). Utilizing the auxiliary ESS 222, the power boost mode is configured to provide a predetermined additional power (e.g., 50 kW) above the full capacity of the main HV battery 220 to the electric motor(s) 128 for a predetermined period of time (e.g., 10-30 seconds). In one example, once the power boost mode is enabled/initiated, the controller 204 monitors for the throttle to exceed a predetermined threshold, and subsequently provides the power boost to the electric motor(s) 128 for the predetermined period of time.

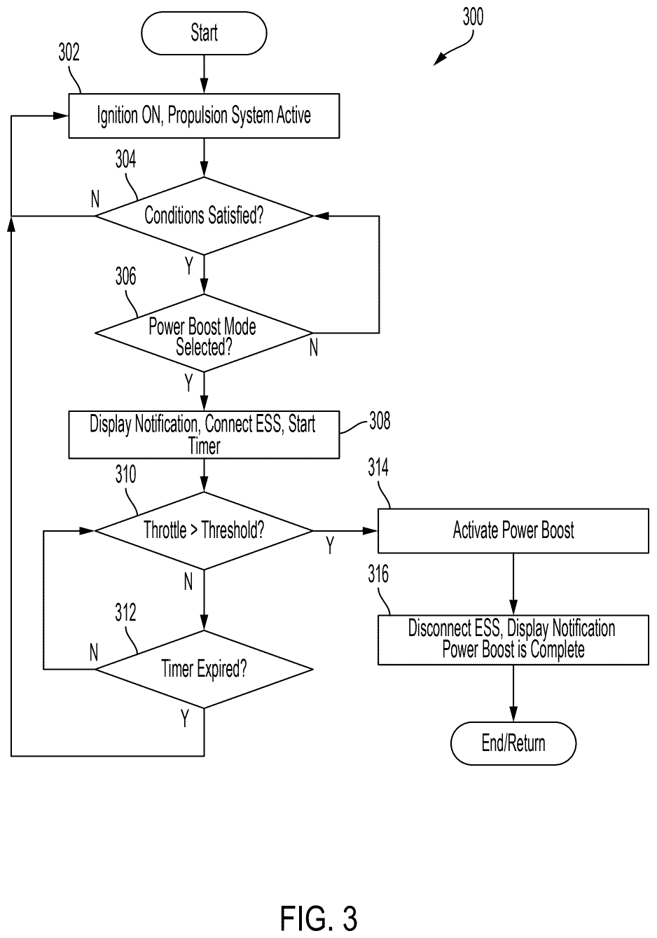

Referring now to FIG. 3, a flow diagram of an example method 300 of controlling the HV battery control system 104 of an electrified vehicle according to the principles of the present application is illustrated. While the components of vehicle 100 and FIGS. 1-2 are referenced for explanatory purposes, it will be appreciated that this method 300 could be applicable to any suitable electrified vehicle. The method begins at 302, with the vehicle 100 ignition ON and the propulsion system 108, 112 active. At 304, the supervisory controller 204 (“control”) determines if the vehicle satisfies one or more conditions to enable the power boost mode. Example conditions include, but are not limited to, shifter in Drive position, HV battery 220 temperature is in a predetermined range, electric motor(s) temperature(s) are in a predetermined range, HV battery 220 state of charge (SOC) is within a predetermined range, etc. If no, control returns to 302. If yes, control proceeds to 306.

At 306, control monitors the vehicle to determine if the driver has selected/initiated the power boost mode. The power boost mode may be selected, for example, via the driver interface 120 (e.g., touchscreen, button on steering wheel, etc.) or by any suitable means. If no, control returns to 304. If yes, at 308, control displays a notification to the driver that the power boost mode is enabled (e.g., on instrument panel display). Control also electrically connects the auxiliary ESS 222 to one or more of the electric motors 128 (if not already connected). Optionally, control may start a timeout timer (e.g., 30 seconds) that deactivates the power boost mode if the timer expires. At 310, control determines if the vehicle throttle (e.g., accelerator pedal) exceeds a predetermined threshold (e.g., accelerator pedal fully depressed). If no, control proceeds to 312. If yes, control proceeds to 314.

At 312, control determines if the timer has expired. If yes, control returns to 302. If no, returns to 310. At 314, if the vehicle throttle exceeds the predetermined threshold, control activates the power boost and provides power from the auxiliary ESS 222 to the one or more electric motors 128 for a predetermined period of time (e.g., 10 seconds). At 316, once the power boost is completed (e.g., time expired), control provides a notification to the driver that the power boost is completed. The auxiliary ESS 222 may also be electrically disconnected from the electric motor 128 at this time. Control then ends or returns to 302 for a new power boost mode activation.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electrified vehicle, comprising:
an electric traction motor configured to generate drive torque;
a high voltage (HV) battery system including a main HV battery for powering the electric traction motor under normal operating conditions;
an auxiliary energy storage system (ESS) configured to selectively provide power to the electric traction motor during a power boost mode; and
a control system including a controller programmed to:
detect a driver selected command to operate the vehicle in the power boost mode;
electrically connect the auxiliary ESS to the electric traction motor; and
initiate the power boost mode, when one or more conditions are satisfied, by supplying power from the auxiliary ESS to the electric traction motor to enable the electric traction motor to operate with a higher power than what is available during the normal operating conditions with the main HV battery.

2. The electrified vehicle of claim 1, wherein the main HV battery has a first voltage, and the auxiliary ESS has a second voltage that is higher than the first voltage.

3. The electrified vehicle of claim 2, wherein the first voltage is approximately 800V and the second voltage is approximately 900V.

4. The electrified vehicle of claim 1, further comprising:
a regenerative braking system configured to generate electrical power with the electric traction motor operating as a generator; and
a boost converter electrically coupled between the electric traction motor and the auxiliary ESS, the boost converter configured to boost voltage from the regenerative braking system to a higher voltage for recharging the auxiliary ESS.

5. The electrified vehicle of claim 1, wherein the auxiliary ESS is a supercapacitor.

6. The electrified vehicle of claim 1, further comprising a power router switch configured to selectively electrically connect the auxiliary ESS to the electric traction motor.

7. The electrified vehicle of claim 1, wherein the one or more conditions comprises a throttle of the vehicle exceeding a predetermined threshold.

8. The electrified vehicle of claim 1, wherein the controller is further programmed to deactivate the power boost mode and disconnect the auxiliary ESS from the electric traction motor after a predetermined period of time has elapsed.

9. The electrified vehicle of claim 1, wherein the controller is further programmed to deactivate the power boost mode if the one or more conditions are not satisfied with a predetermined amount of time.

10. The electrified vehicle of claim 1, wherein the electric traction motor comprises:
a first electric traction motor configured to drive a first set of vehicle wheels; and
a second electric traction motor configured to drive a second set of vehicle wheels.

11. The electrified vehicle of claim 10, wherein during the power boost mode, the main HV battery powers the first electric traction motor, and the auxiliary ESS powers the second electric traction motor.

12. A method of operating an electrified vehicle having an electric traction motor, a main high voltage (HV) battery for powering the electric traction motor under normal operating conditions, and an auxiliary energy storage system (ESS) configured to selectively provide power to the electric traction motor during a power boost mode, the method comprising:
detecting, by a controller, a driver selected command to operate the vehicle in the power boost mode;
electrically connecting, by the controller, the auxiliary ESS to the electric traction motor; and
initiating, by the controller, the power boost mode when one or more conditions are satisfied, by supplying power from the auxiliary ESS to the electric traction motor to enable the electric traction motor to operate with a higher power than what is available during the normal operating conditions with the main HV battery.

13. The method of claim 12, wherein the main HV battery has a first voltage, and the auxiliary ESS has a second voltage that is higher than the first voltage.

14. The method of claim 12, wherein the electrified vehicle further comprises:
a regenerative braking system configured to generate electrical power with the electric traction motor operating as a generator;
a boost converter electrically coupled between the electric traction motor and the auxiliary ESS, the boost converter configured to boost voltage from the regenerative braking system to a higher voltage for recharging the auxiliary ESS; and
a power router switch configured to selectively electrically connect the auxiliary ESS to the electric traction motor.

15. The method of claim 12, wherein the auxiliary ESS is an ultracapacitor.

16. The method of claim 12, wherein the one or more conditions comprises a throttle of the vehicle exceeding a predetermined threshold.

17. The method of claim 12, further comprising:
deactivating, by the controller, the power boost mode and disconnecting the auxiliary ESS from the electric traction motor after a predetermined period of time has elapsed.

18. The method of claim 12, further comprising:
deactivating, by the controller, the power boost mode if the one or more conditions are not satisfied with a predetermined amount of time.

19. The method of claim 12, wherein the electric traction motor comprises:
a first electric traction motor configured to drive a first set of vehicle wheels; and
a second electric traction motor configured to drive a second set of vehicle wheels.

20. The method of claim 12, further comprising:
powering the first electric traction motor with the main HV battery during the power boost mode; and
powering the second electric traction motor with the auxiliary ESS during the power boost mode.
